(19) United States
(12) Patent Application Publication
(10) Pub. No.: US 2009/0082927 A1
(43) Pub. Date: Mar. 26, 2009

(54) INTEGRATED SEAT CONDITIONING AND MULTI-COMPONENT CONTROL MODULE

(75) Inventors: Marinko Lazanja, Windsor (CA); Robert Jarnevic, Windsor (CA); Jan Beska, Belle River (CA); Goran Bajic, Belle River (CA)

Correspondence Address: DOBRUSIN & THENNISCH PC, 29 W LAWRENCE ST, SUITE 210, PONTIAC, MI, 48342, US

(73) Assignee: W.E.T. Automotive Systems AG

(21) Appl. No.: 12/198,295

(22) Filed: Aug. 26, 2008

Related U.S. Application Data
(60) Provisional application No. 60/974,942, filed on Sep. 25, 2007.

(51) Int. Cl. G06F 17/00; B60H 1/00; B60N 2/56

(52) U.S. Cl. 701/48; 165/203

(57) ABSTRACT

An integrated control unit for a vehicle comprising a housing adapted to package an air fluid mover, a plurality of microprocessors in electrical communication with and a plurality of connectors and the connectors are adapted send and receive electrical signals to and from the plurality of microprocessors and at least one other component within the vehicle. The housing also including at least one opening, for fluidly communicating air fluid to the air fluid mover from the vehicle, and at least one other opening for fluidly communicating air fluid from the air fluid mover to the vehicle.

### CLAIM OF PRIORITY

The present application claims the benefit of the filing date of U.S. Provisional Application Ser. No. 60/974942, filed Sep. 25, 2007, hereby incorporated by reference.

### FIELD OF THE INVENTION

The present invention relates to a unit to control vehicle component functions and to provide conditioning to a given vehicle seat, more particularly to provide an integrated module that performs these functions and that includes a seat conditioning device.

### BACKGROUND OF THE INVENTION

It is well known that vehicles are being equipped with a variety of features to enhance the comfort of its occupants. Such features include items such as, but not limited to: heated and cooled seats, adjustable lumbar support, adjustable seat location positioning, adjustable seat belt positioning, heated steering wheels, multi-axis steering wheel positioning, movable brake and accelerator pedals, and automatically adjusted side view mirrors. As with many of these features, they may be offered with or without a memory function. The memory function (e.g. implemented via a memory/control module) allows the occupant to set and store a preferred setting for the given feature which then can be used to reset the setting of the given feature for the occupant next time they use the vehicle. When no memory function is present, the function typically is controlled via a control module.

The amount of energy used, number of memory and/or control modules and module packaging space needed to implement these multiple features can be prohibitive within a vehicle environment. It is desirous to limit the number of such modules so that the total energy required to run these modules is limited as well as possibly providing a power shedding function (e.g. controlling the total power usage of all the integrated modules at any given time). It is also desirous to limit the number of such modules so that the limited packaging space with a vehicle is optimized while keeping costs down. To this end, the present invention seeks to improve on these issues by integrating the various memory and control modules into a single integrated unit along with the seat conditioning unit already present in the vehicle.

### SUMMARY OF THE INVENTION

The present invention is an improved module that integrates the various memory and control modules from a number of vehicle components into an integrated unit along with a seat conditioning unit (e.g. ventilation, heating and cooling, or both) into a stand alone package.

This presents the advantage of combining multiple modules into an integrated unit that has a single power source, a single control point, optionally a single memory point, and in a single packaging space.

Accordingly, pursuant to one aspect of the present invention, there is contemplated an integrated control unit for a vehicle comprising a housing adapted to package an air fluid mover, a plurality of microprocessors in electrical communication with and a plurality of connectors; the housing including at least one opening for fluidly communicating air fluid to the air fluid mover from the vehicle, further wherein the housing including at least one opening for fluidly communicating air fluid from the air fluid mover to the vehicle, wherein the connectors are adapted send and receive electrical signals to and from the plurality of microprocessors and at least one other component within the vehicle.

The invention may be further characterized by one or any combination of the features described herein, such as wherein the plurality of microprocessors includes at least one memory storage processor; the plurality of microprocessors includes at least one control processor; including an air fluid conditioner in fluid communication with the air fluid mover for providing conditioned air fluid to the vehicle through a seat; and the at least one other component within the vehicle including: a lumbar, a heater, a power pedal, a memory input device, a seat conditioner, a adjustable steering wheel, a heated steering wheel, an adjustable side mirror, a seat adjustment mechanism, a seat belt adjustment mechanism, a power adjusted head restraint, or any combination thereof.

Accordingly, pursuant to another aspect of the present invention, there is contemplated an integrated control unit for a vehicle comprising a housing adapted to package an air fluid mover in fluid communication with an air fluid conditioning device, a plurality of microprocessors in electrical communication with and a plurality of connectors; the housing includes at least one opening for fluidly communicating air fluid to the air fluid mover from the vehicle, further wherein the housing includes at least two openings for fluidly communicating air fluid from the air fluid conditioning device to the vehicle, and wherein the connectors are adapted send and receive electrical signals to and from the plurality of microprocessors and at least one other component within the vehicle.

The invention may be further characterized by one or any combination of the features described herein, such as the plurality of microprocessors including at least one memory storage processor; the plurality of microprocessors including at least one control processor; the at least one other component within the vehicle including: a lumbar, a heater, a power pedal, a memory input device, a seat conditioner, a adjustable steering wheel, a heated steering wheel, an adjustable side mirror, a seat adjustment mechanism, a seat belt adjustment mechanism, a power adjusted head restraint, or any combination thereof.

Accordingly, pursuant to another aspect of the present invention, there is contemplated an integrated control unit for a vehicle comprising a housing adapted to package an air fluid mover in fluid communication with an thermoelectric air fluid conditioning device, a plurality of control microprocessors in electrical communication with and a plurality of connectors, the control microprocessors communicatively connected to a plurality of memory storage microprocessors, and a power supply connector adapted to receive electrical power from the vehicle and provide power to the microprocessors; the housing includes at least one opening for fluidly communicating air fluid to the air fluid mover from the vehicle, further wherein the housing includes at least two openings for fluidly communicating air fluid from the thermoelectric air fluid conditioning device to a seat, wherein the connectors are adapted send and receive electrical signals to and from the plurality of control microprocessors and at least one other component within the vehicle.

The invention may be further characterized by one or any combination of the features described herein, such as the at least one other component within the vehicle includes: a lumbar, a heater, a power pedal, a memory input device, a seat conditioner, a adjustable steering wheel, a heated steering wheel, an adjustable side mirror, a seat adjustment mechanism, a seat belt adjustment mechanism, a power adjusted head restraint, or any combination thereof.

Accordingly, pursuant to yet another aspect of the present invention, there is contemplated a method of conditioning a vehicle and controlling vehicle component functions, including the steps of (a) providing a integrated control unit that houses an air fluid mover in fluid communication with an air fluid conditioner, a plurality of microprocessors in electrical communication with a plurality of connectors, at least one of the plurality of connectors in electrical communication with at least one other vehicle component; (b) inputting power to the plurality of microprocessors, the air fluid mover, and the air fluid conditioner via at least one of the plurality of connectors; (c) providing air fluid from a vehicle environment to the air fluid mover; (d) conditioning the air fluid in the air fluid conditioner; (e) outputting the air fluid from the air fluid conditioner to the vehicle environment; (f) inputting an input signal to the at least one of the plurality of microprocessors via the electrical communication from at least one of the other vehicle component; and (g) outputting an output signal from at least one of the plurality of microprocessors via the electrical communication to control the at least one other vehicle component.

### BRIEF DESCRIPTION OF THE DRAWINGS

FIG. 1 illustrates an exemplary integrated module per the teachings of the present invention.

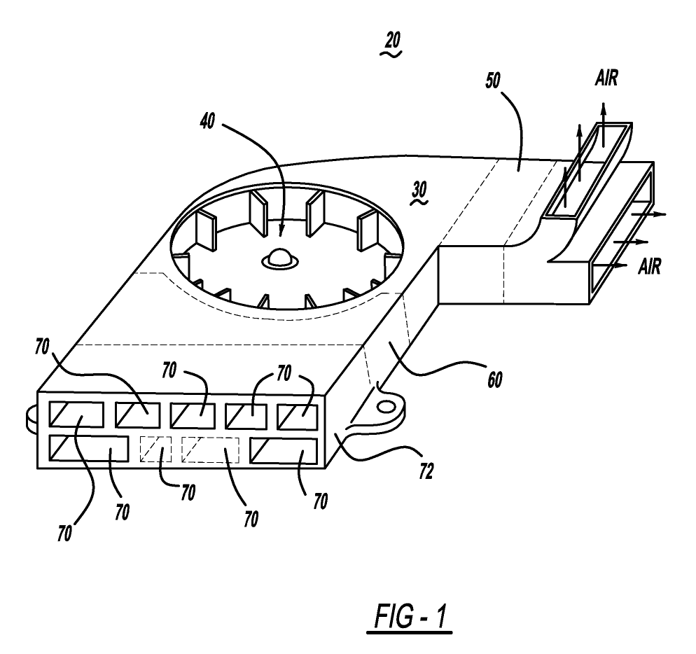

FIG. 2 illustrates a second exemplary integrated module per the teachings of the present invention.

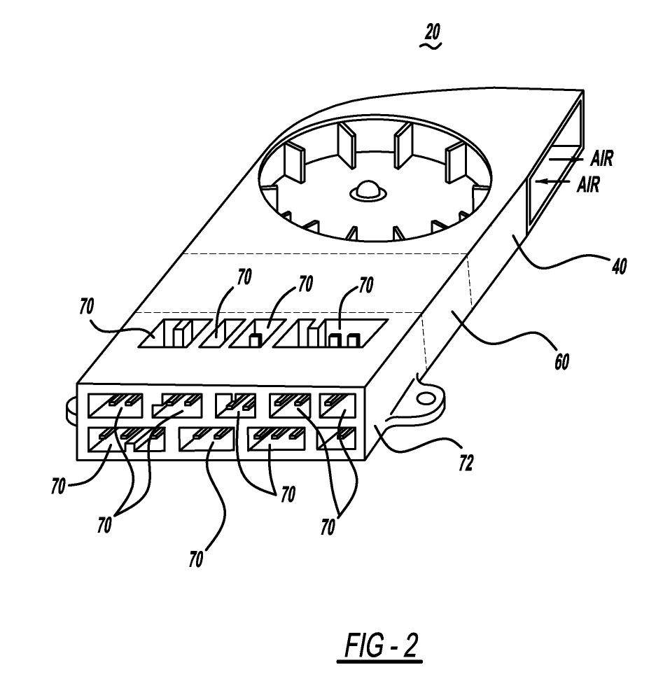

### DETAILED DESCRIPTION

The present invention is directed at an improved integrated module 20 that can provide conditioned or ventilated air fluid in a seat and control various other component functions with a vehicle.

In general, the invention contemplates an integrated control unit for a vehicle that includes a housing 30 (e.g. a unitary module located in a seat) adapted to package multiple components. Such components may include an air fluid mover 40 (e.g. blower), an air fluid conditioner 50 (e.g. a thermoelectric type air fluid conditioner “TED”), a plurality of microprocessors (e.g. control processors, memory storage processors, printed circuit boards “PCB”, or any combination thereof located in a micro processor zone 60), and a plurality of connectors 70 (located in a connection zone 72). It is contemplated that these connectors provide an interface between the processors of the unit or module and at least one or more vehicle components (not shown) (e.g. a lumbar (pneumatic or electric), a heater, a power pedal, a memory input device, a seat conditioner, a adjustable steering wheel, a heated steering wheel, an adjustable side mirror, a seat adjustment mechanism, a seat belt adjustment mechanism, a power adjusted head restraint, seatbelt chime, air ionizer, active noise cancellation device, or any combination thereof allowing input and output signals to go between them. This integrated module 20 can serve as a single point of control and contact for the vehicle components, allowing a vehicle manufacturer to optimize the number of modules and the overall power consumption needed to control the components. It is also contemplated that there may be a plurality of these integrated modules in a vehicle, where one may act as a master controller and the others as slave units. Additionally, the integrated module may function as a HVAC interface (e.g. when the AC is high that the blower can run on a higher speed that the occupant will not hear. As the AC is reduced the blower will automatically reduce speed to be less then the HVAC noise).

High Current loads may dictate the requirement for larger gage wiring to the seat system, higher current rated connectors and generally add to the electrical load of the vehicle. The TED and the Seat Motors (possibly 4 to 6 motors in a seat) are high current devices. The seat motors are inductive which means that there is an initial surge current that is much higher that the normal running current.

During Cooling operation the TED is drawing a high current of approximately 8 amps (approximately 4 amps per unit and there are 2 units per seat). The TED can be turned off for short periods of time with out turning off the fan motor and therefore with no audible impact and with a very small impact to the general performance of the cooling system. The Integrated Seat Conditioning and Multi-Component Module should be able to manage the peak power consumption and will be able to do so in a manner transparent to the end user by the performing the following:

1. Turning off the TED prior to and during the starting of the seat motors.

2. Turning off the TED prior to and during the starting and operation of the seat motors.

3. Staggering the starting of inductive loads such that the initial inrush currents do not occur at the same time.

Another approach that can be taken to manage system power that would not be transparent to the end user would be to allow only one high current device or limit the number of high current devices from operating at the given time.

Further it is contemplated that the housing may include at least one opening for fluidly communicating air fluid to the air fluid mover from the vehicle (e.g. via an air fluid intake) and further may include at least one opening (e.g. a port zone) for fluidly communicating air fluid from the air fluid mover back to the vehicle (e.g. through a seating surface). A typical illustrative example of this fluid communication to and from this type of air fluid mover can be found in U.S. Pat. Nos. 6,857,697 and 7,197,801 hereby incorporated by reference for all purposes.

To further describe a typical illustrative example of this fluid communication to and from this type of air fluid mover through a seat, the vehicle seat includes a seat cushion component and a seat backrest component, at least one of which provides a seat cushion and an air fluid-permeable trim surface at the occupant contact areas of the seat. This exemplary system includes an insert located beneath the trim surface of each ventilated component. The insert includes a first layer having a heater integrated therein and a second layer formed of spacer material wherein the second layer defines an open space. The system also includes a positive pressure blower in fluid communication with the insert for moving air fluid through the open space and at least partially past an occupant in the seat. A tubular structure is preferably provided in the system for providing the fluid communication between the insert and the fluid mover.

To further describe another typical illustrative example of this fluid communication to and from this type of air fluid mover through a seat there is disclosed a seat insert, a method of forming the seat insert and a ventilated seat that is preferably suitable for an automotive vehicle. The insert preferably includes a forward layer, a rearward layer and a middle layer, although greater or fewer layers may be included. When included, the forward layer typically includes a first barrier sub-layer, a heater sub-layer, a plurality of openings or a combination thereof. In preferred embodiments, the first barrier sub-layer is formed of a plastic material; the heater sub-layer is formed as a lay-wire heater or both.

The rearward layer, when included, has a second barrier sub-layer, an opening or both. In a preferred embodiment, the second barrier sub-layer is formed of a plastic material like the first barrier sub-layer. The middle layer typically includes a spacer sub-layer defining an open space. In a preferred embodiment, the spacer sub-layer is formed of interwoven polymeric strand material. An air fluid mover (e.g., a blower) is attached to the insert and is preferably at least partially disposed within the at least one opening of the rearward layer, although not required. The air fluid mover is in fluid communication with the plurality of openings in the forward layer, the open space of the spacer sub-layer or both.

In one embodiment, the plurality of microprocessors includes at least one memory storage processor adapted to store setting data for any number of vehicle components (e.g. seat positions, heating and cooling, steering wheel location, side mirror location, and the like). A typical memory storage processor can be found in U.S. Pat. Nos. 4,510,426; 4,845,620; and 7,239,096 herein incorporated by reference for all purposes. In another embodiment the plurality of microprocessors includes at least one control processor. A typical control processor can also be found the above in U.S. Patents.

To further describe a typical illustrative example of this typical memory storage processor and control microprocessors, in a seating example, the electronic controller features a microcomputer which receives command signals from a first and second group of operator actuable switches, present position signals from a monitoring circuit, and stored position signals from a memory storage processor, for generating control signals for directing a motive power means to adjust the position of an automobile seat. In a standby mode, only the memory storage processor is supplied with electrical power in order to minimize the power drain on the d.c. power source for the motive power means, i.e. typically an automobile battery. However, whenever any of the operator actuable switches are actuated to modify the position of the seat, a run mode is assumed and power is supplied to the microcomputer. An initialization sequence is commenced which includes down loading the stored position data from the memory storage processor into the internal RAM memory circuit of the microcomputer.

To further describe another typical illustrative example of this typical memory storage processor and control microprocessors, in a seating example, the control apparatus includes a reversible motor operative to drive the seat in either of two opposite directions within a travel path of limited extent, means for producing digital signals during operation of the motor representative of the position of the seat within the travel path and logic and signal storage means. The signal storage means includes at least first and second memories, the first memory being receptive of the digital signals for storing therein data representative of the present position of the seat within the travel path. The controller further includes manually selective position control means for setting the second memory to store data representative of a recall position within the travel path for a seat. The controller further includes position recall means which are manually actuatable to signal the logic and storage means to initiate operation of the motor to drive the seat toward the recall position. The means for producing the digital signals is operative during operation of the motor to produce signals for transmission to the memory means to control the drive of the seat to the recall position. The improvement comprises structuring the memory means to be of limited capacity, with at least the first memory being of less capacity than is required for storing 2N digital signals, where N is equal to the number of digital signals produced during the drive of the seat through the extent of the travel path in one direction. Further, compensating means appropriately decrement or increment the data representative of a recall position in response to the first memory reaching a capacity limit, for maintaining an accurate relation between the data respectively representative of the actual position and the recall position of the seat.

In still another embodiment, the invention contemplates having both control microprocessors (“controllers”) and memory storage processors (“storage”) in the module. In this embodiment, it is contemplated that a given processor can control multiple components within the vehicle, thus providing a synergistic effect where the number of processors required to control the plurality of components is less than what would be required without the present invention.

In this embodiment, it is also contemplated that electrical signals move between the controllers and the storage and ultimately to any number of devices within the vehicle (e.g. other duplicate or similar modules as described in the present invention located in other seats, various vehicle components, or both). This allows a person to set a given device to a preferred setting, store that information in the storage, and have the device return to that preferred setting when the module is activated (e.g. by hitting a memory button, by a signal from a key fob, or the like).

In still another embodiment, the invention contemplates having the air fluid mover without the conditioning device, thus providing air fluid movement alone (e.g. ventilating a seat).

The present invention also contemplates a method of conditioning a vehicle and controlling vehicle component functions by the steps of:

Providing the integrated control unit and inputting power to the plurality of microprocessors, the air fluid mover, and the air fluid conditioner via at least one of the plurality of connectors. Providing air fluid from a vehicle environment to the air fluid mover, optionally conditioning the air fluid in the air fluid conditioner and then outputting the air fluid from the air fluid conditioner (or directly from the air fluid mover) to the vehicle environment (e.g. through the seat). The unit also can input an input signal to the at least one of the plurality of microprocessors via the electrical communication from at least one of the other vehicle component and output an output signal from at least one of the plurality of microprocessors via the electrical communication to control the at least one other vehicle component.

Unless stated otherwise, the method depicted herein is not intended to be restrictive of the invention, and other dimensions or geometries are possible. In addition, while a feature of the present invention may have been described in the context of only one of the illustrated embodiments, such feature may be combined with one or more other features of other embodiments, for any given application.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. An integrated control unit for a vehicle comprising:
a housing adapted to package an air fluid mover, a plurality of microprocessors in electrical communication with and a plurality of connectors;
wherein, the housing includes at least one opening for fluidly communicating air fluid to the air fluid mover from the vehicle, further wherein the housing includes at least one opening for fluidly communicating air fluid from the air fluid mover to the vehicle, wherein the connectors are adapted send and receive electrical signals to and from the plurality of microprocessors and at least one other component within the vehicle.

2. The integrated control unit of claim 1, wherein the plurality of microprocessors includes at least one memory storage processor.

3. The integrated control unit of claim 1, wherein the plurality of microprocessors includes at least one control processor.

4. The integrated control unit of claim 1, further including an air fluid conditioner in fluid communication with the air fluid mover for providing conditioned air fluid to the vehicle through a seat.

5. The integrated control unit of claim 1, wherein the at least one other component within the vehicle includes: a lumbar, a heater, a power pedal, a memory input device, a seat conditioner, a adjustable steering wheel, a heated steering wheel, an adjustable side mirror, a seat adjustment mechanism, a seat belt adjustment mechanism, a power adjusted head restraint, or any combination thereof.

6. An integrated control unit for a vehicle comprising:
a housing adapted to package an air fluid mover in fluid communication with an air fluid conditioning device, a plurality of microprocessors in electrical communication with and a plurality of connectors;
wherein, the housing includes at least one opening for fluidly communicating air fluid to the air fluid mover from the vehicle, further wherein the housing includes at least two openings for fluidly communicating air fluid from the air fluid conditioning device to the vehicle, wherein the connectors are adapted send and receive electrical signals to and from the plurality of microprocessors and at least one other component within the vehicle.

7. The integrated control unit of claim 6, wherein the plurality of microprocessors includes at least one memory storage processor.

8. The integrated control unit of claim 6, wherein the plurality of microprocessors includes at least one control processor.

9. The integrated control unit of claim 6, wherein the at least one other component within the vehicle includes: a lumbar, a heater, a power pedal, a memory input device, a seat conditioner, a adjustable steering wheel, a heated steering wheel, an adjustable side mirror, a seat adjustment mechanism, a seat belt adjustment mechanism, a power adjusted head restraint, or any combination thereof.

10. An integrated control unit for a vehicle comprising:
a housing adapted to package an air fluid mover in fluid communication with an thermoelectric air fluid conditioning device, a plurality of control microprocessors in electrical communication with and a plurality of connectors, the control microprocessors communicatively connected to a plurality of memory storage microprocessors, and a power supply connector adapted to receive electrical power from the vehicle and provide power to the microprocessors,
wherein, the housing includes at least one opening for fluidly communicating air fluid to the air fluid mover from the vehicle, further wherein the housing includes at least two openings for fluidly communicating air fluid from the thermoelectric air fluid conditioning device to a seat, wherein the connectors are adapted send and receive electrical signals to and from the plurality of control microprocessors and at least one other component within the vehicle.

11. The integrated control unit of claim 10, wherein the at least one other component within the vehicle includes: a lumbar, a heater, a power pedal, a memory input device, a seat conditioner, a adjustable steering wheel, a heated steering wheel, an adjustable side mirror, a seat adjustment mechanism, a seat belt adjustment mechanism, a power adjusted head restraint, or any combination thereof.

12. A method of conditioning a vehicle and controlling vehicle component functions, including the steps of:
(a) providing a integrated control unit that houses an air fluid mover in fluid communication with an air fluid conditioner, a plurality of microprocessors in electrical communication with a plurality of connectors, at least one of the plurality of connectors in electrical communication with at least one other vehicle component;
(b) inputting power to the plurality of microprocessors, the air fluid mover, and the air fluid conditioner via at least one of the plurality of connectors;
(c) providing air fluid from a vehicle environment to the air fluid mover;
(d) conditioning the air fluid in the air fluid conditioner;
(e) outputting the air fluid from the air fluid conditioner to the vehicle environment;
(f) inputting an input signal to the at least one of the plurality of microprocessors via the electrical communication from at least one of the other vehicle component; and
(g) outputting an output signal from at least one of the plurality of microprocessors via the electrical communication to control the at least one other vehicle component.
